(19) United States
(12) Patent Application Publication
(10) Pub. No.: US 2025/0301491 A1
(43) Pub. Date: Sep. 25, 2025

(54) LOW LATENCY TRAFFIC PROTECTION IN WIRELESS NETWORKS

(71) Applicant: Samsung Electronics Co., Ltd., Suwon-si (KR)

(72) Inventors: Yue Qi, Plano, TX (US); Vishnu Vardhan Ratnam, Frisco, TX (US); Bilal Sadiq, Plano, TX (US); Boon Loong Ng, Plano, TX (US); Peshal Nayak, Plano, TX (US); Rubayet Shafin, Frisco, TX (US)

(21) Appl. No.: 19/061,899

(22) Filed: Feb. 24, 2025

Related U.S. Application Data
(60) Provisional application No. 63/568,886, filed on Mar. 22, 2024.

(51) Int. Cl. H04W 72/512; H04W 72/27

(52) U.S. Cl. CPC H04W 72/512; H04W 72/27

(57) ABSTRACT

A first access point (AP) for facilitating communication in a wireless network. The first AP receives, from a second AP, a first request frame requesting coordination so that the first AP and one or more stations (STAs) in a basic service set (BSS) of the first AP avoid using a first resource unit (RU), wherein the first RU is dedicated for low-latency traffic transmission and the first request frame includes a first duration for the coordination. The first AP transmits, to the second AP, a first response frame accepting the request of the first request frame.

### CROSS REFERENCE TO RELATED APPLICATION

This application claims benefit of U.S. Provisional Application No. 63/568,886, entitled “Low Latency Resource Unit Protection in Multiple AP Networks,” filed on Mar. 22, 2024, in the United States Patent and Trademark Office, the entire contents of which are hereby incorporated by reference.

### TECHNICAL FIELD

This disclosure relates generally to a wireless communication system, and more particularly to, for example, but not limited to, low latency traffic transmission in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and procedure for low-latency resource protection.

An aspect of the disclosure provides a first access point (AP) for facilitating communication in a wireless network. The first AP comprises a memory and a processor coupled to the memory. The processor is configured to cause receiving, from a second AP, a first request frame requesting coordination so that the first AP and one or more stations (STAs) in a basic service set (BSS) of the first AP avoid using a first resource unit (RU), wherein the first RU is dedicated for low-latency traffic transmission and the first request frame includes a first duration for the coordination. The processor is further configured to cause transmitting, to the second AP, a first response frame accepting the request of the first request frame.

In an embodiment, the first request frame includes an identification for a STA designated to use the first RU for low-latency traffic transmission.

In an embodiment, the first request frame is a stream classification service (SCS) request frame including classification information and parameters provided by one or more STAs associated with the first AP. The first response frame is an SCS response frame.

In an embodiment, the processor is further configured to cause transmitting, to the second AP, a third request frame requesting coordination so that the second AP and one or more STAs in a BSS of the second AP avoid using a second RU, wherein the second RU is dedicated for low-latency traffic transmission. The processor is further configured to cause receiving, from the second AP, a fourth response frame accepting the request of the third request frame.

In an embodiment, the processor is further configured to cause transmitting, to the one or more STAs, a second request frame requesting that the one or more STAs avoid using the first RU for the first duration. The processor is further configured to cause receiving, from at least one of the one or more STAs, a second response frame accepting the request of the second request frame.

In an embodiment, the first response frame includes a second duration for setting a network allocation vector (NAV) in the BSS of the first AP, the second duration being determined based on the first duration.

In an embodiment, the processor is further configured to cause transmitting, to the second AP, a third response frame deferring acceptance of the first request frame for a period of time in response to the first request frame. The processor is further configured to cause performing communication with the one or more STAs. The processor is further configured to cause transmitting, to the second AP, the first response frame accepting the request of the first request frame.

In an embodiment, the first request frame includes information indicating a presence of low-latency traffic on the first RU.

An aspect of the disclosure provides a first AP for facilitating communication in a wireless network. The first AP comprises a memory and a processor coupled to the memory. The processor is configured to cause transmitting, to a second AP, a first request frame requesting coordination so that the second AP and one or more STAs in a BSS of the second AP avoid using a first RU, wherein the first RU is dedicated for low-latency traffic transmission. The processor is further configured to cause receiving, from the second AP, a first response frame accepting the request of the first request frame.

In an embodiment, the first request frame includes an identification for a STA designated to use the first RU for low-latency traffic transmission.

In an embodiment, the first request frame is an SCS request frame including classification information and parameters provided by one or more STAs associated with the first AP. The first response frame is an SCS response frame.

In an embodiment, the processor is further configured to cause receiving, from the second AP, a second request frame requesting coordination so that the first AP and one or more STAs in a BSS of the first AP avoid using a second RU, wherein the second RU is dedicated for low-latency traffic transmission. The processor is further configured to cause transmitting, to the second AP, a second response frame accepting the request of the second request frame.

In an embodiment, the processor is further configured to cause transmitting, to the one or more STAs, a frame indicating information associated with the second RU. In an embodiment, the processor is further configured to cause receiving, from a STA associated with the first AP, a third request frame requesting an RU for a low-latency traffic transmission. The processor is further configured to cause transmitting, to the STA associated with the first AP, a third response frame accepting the third request and allocating the first RU.

In an embodiment, the first request frame includes information indicating a presence of low-latency traffic on the first RU.

An aspect of the disclosure provides a method performed by a first AP in a wireless network. The method comprises receiving, from a second AP, a first request frame requesting coordination so that the first AP and one or more STAs in a BSS of the first AP avoid using a first RU, wherein the first RU is dedicated for low-latency traffic transmission and the first request frame includes a first duration for the coordination. The method further comprises transmitting, to the second AP, a first response frame accepting the request of the first request frame.

In an embodiment, the first request frame includes an identification for a STA designated to use the first RU for low-latency traffic transmission.

In an embodiment, the first request frame is a stream classification service (SCS) request frame including classification information and parameters provided by one or more STAs associated with the first AP. The first response frame is a SCS response frame.

In an embodiment, the method further comprises transmitting, to the second AP, a third request frame requesting coordination so that the second AP and one or more STAs in a BSS of the second AP avoid using a second RU, wherein the second RU is dedicated for low-latency traffic transmission. The method further comprises receiving, from the second AP, a fourth response frame accepting the request of the third request frame.

In an embodiment, the method further comprises transmitting, to the one or more STAs, a second request frame requesting that the one or more STAs avoid using the first RU for the first duration. The method further comprises receiving, from at least one of the one or more STAs, a second response frame accepting the request of the second request frame.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example multiple AP (MAP) network with a P2P group in accordance with an embodiment.

FIG. 5 shows an example scenario of an RU dedicated for RTA traffic being occupied by OBSS STAs when the RTA traffic arrives in accordance with an embodiment.

FIG. 6 shows an example multiple AP (MAP) network with an OBSS STA in accordance with an embodiment.

FIG. 7 shows an example frame exchange with an immediate response by a coordinating AP in accordance with an embodiment.

FIG. 8 shows an example of flow handling using NAV in accordance with an embodiment.

FIG. 9 shows an example frame exchange with an immediate response by the coordinated AP in accordance with an embodiment.

FIG. 10 shows an example of flow handling using an LL request or indication in accordance with an embodiment.

FIG. 11 shows an example frame exchange with a delayed response by the coordinated AP in accordance with an embodiment.

FIG. 12 shows an example frame exchange between two APs with LL traffic in their respective BSSs in accordance with an embodiment.

FIG. 13 shows an example LL negotiation procedure between a coordinating AP and a coordinated AP in accordance with an embodiment.

FIG. 14 shows an example frame exchange indicating LL information to a P2P group in accordance with an embodiment.

FIG. 15 shows an example process for a coordinating AP-side negotiation procedure in accordance with an embodiment.

FIG. 16 shows an example process for a coordinated AP-side negotiation procedure in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

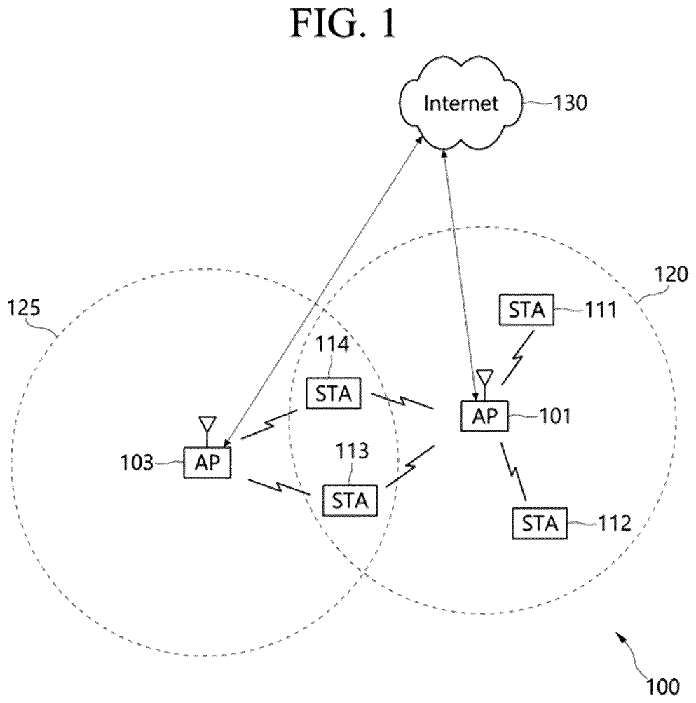

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

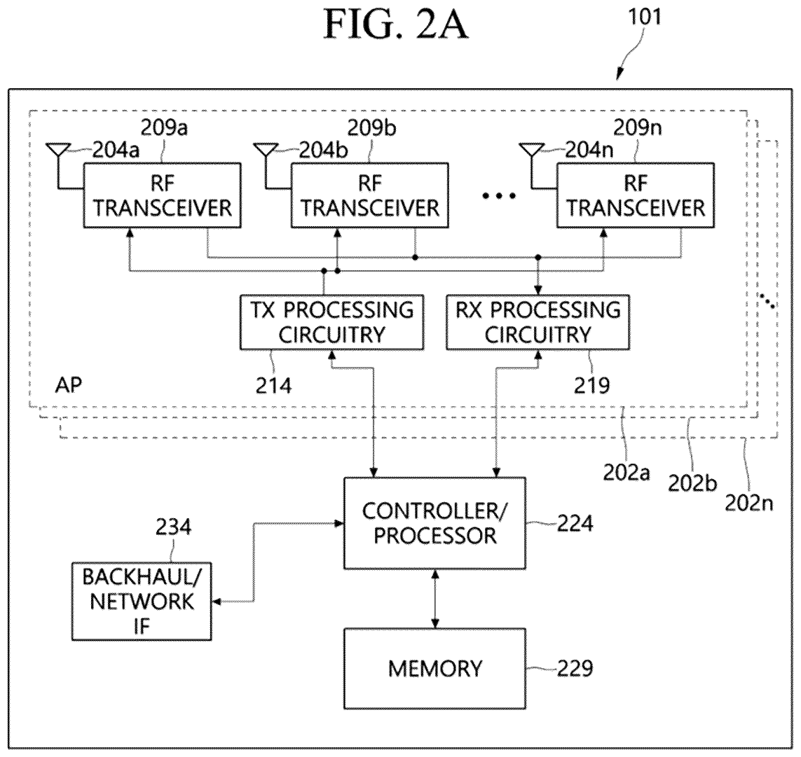

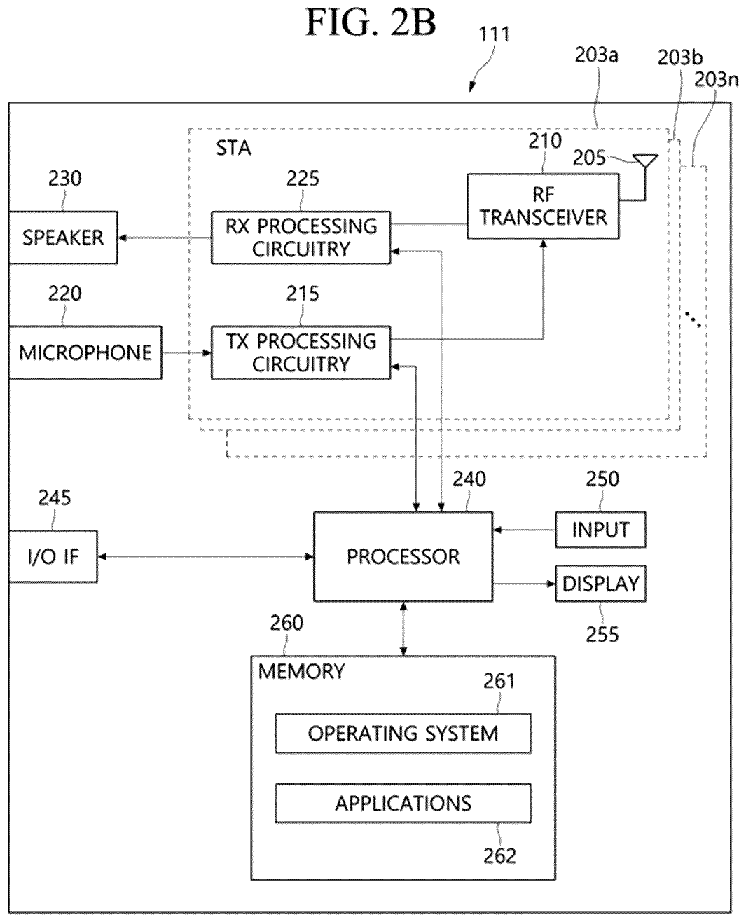

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

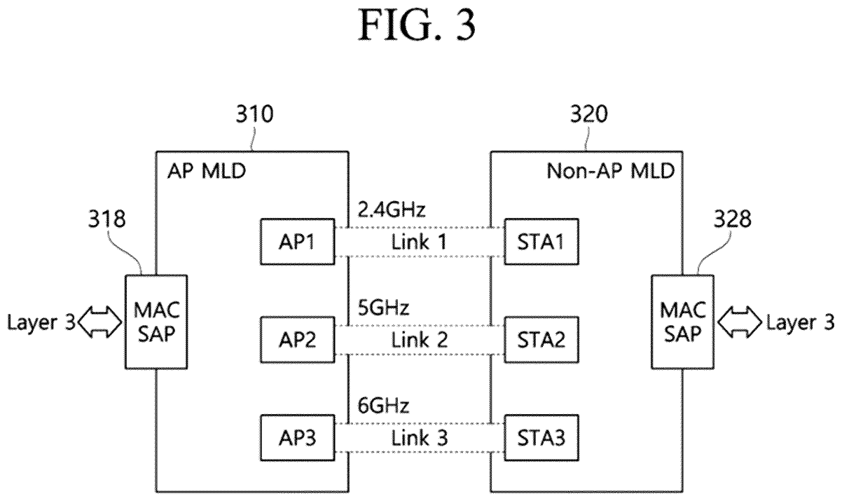

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Part 11: Wireless LAN Medium Access Control (MAC) and Physical Layer (PHY) Specifications—Amendment 8: Enhancements for extremely high throughput (EHT).”

In an infrastructure Wireless LAN network, a basic service set (BSS) typically refers to a network topology comprising an AP or an AP MLD, and all the non-AP devices associated with that AP or AP MLD. A BSS defines an operating bandwidth indicating the frequency resources that the devices belonging to the BSS may use for transmission, and rules on how the BSS devices may contend for the operating bandwidth. In particular, a Wireless LAN network BSS defines one of the 20 MHz channels of its operating bandwidth as the primary channel, and any device in that BSS is allowed to initiate transmission if the primary channel is sensed as IDLE after performing a required random back-off. The transmission is normally restricted to that primary 20 MHz and the duration of the transmission is called a transmit opportunity (TXOP) duration. However, if any non-primary channel of the BSS, such as a 20 MHz channel that lies within the operating bandwidth but is not the primary channel, is also sensed as IDLE for a priority interframe spacing (PIFS) duration before the time when the transmit opportunity starts on the primary channel for a Wireless LAN network device, the device man additionally also transmit on that non-primary channel. This mechanism is known as channel bonding and was further enhanced with the concept of preamble puncturing.

For any channel, primary or non-primary, a Wireless LAN network device has two channel sensing mechanisms to sense the channel state. The channel state is determined as being IDLE/BUSY. The first sensing mechanism is preamble detection where a Wireless LAN network device determines a 20 MHz channel as being BUSY if it can successfully detect a Wireless LAN network preamble on that channel with a received power higher than −82 dBm. The second sensing mechanism is energy detection where a Wireless LAN network device determined a 20 MHz channel as being BUSY if it senses any power on that channel with a received power higher than −62 dBm. A Wireless LAN network device determines a 20 MHz channel as IDLE when neither preamble detection nor energy detection determines the 20 MHz channel as BUSY.

Recently, in the discussions for the latest generation of WiFi standard, IEEE 802.11bn, significant focus has been given for the need to reduce the channel access delay for low-latency traffic required by real-time applications (RTAs). In fact, the approved PAR for IEEE 802.11bn intends to define at least one mode of operation capable of improving the tail of the latency distribution and jitter compared to Extremely High Throughput MAC/PHY operation. There is a need to reduce the low latency for the increasing demand of RTA in 11bn. Thus, more stringent requirements are needed to meet the demands of new applications, such as metaverse, augmented and virtual reality, robotics, industrial automation for industrial IoT, logistics and smart agriculture. Establishing lower latency will lead to better customer experience, particularly in the case of latency/jitter mattering. Low latency communication has become increasingly more important, becoming an essential building block for RTA. For example, some use cases require at least less than 5 ms for latency and 2 ms for jitter as shown in Table 1.

Table 1 shows characteristics of low latency traffic in use cases.

TABLE 1

| | Intra BSS | Jitter | | Data |
|---|---|---|---|---|
| | Latency | variance | Packet | rate |
| Use cases | [ms] | [ms] | loss | [Mbps] |
| Real-time | <5 | <2 | <0.1% | <1 |
| gaming | | | | |
| Cloud | <10 | <2 | Near- | <0.1 (Reverse Link) |
| gaming | | | lossless | >5 Mbps (Forward |
| | | | | link) |
| Real-time | <3~10 | <1~2.5 | Near- | 100~28,000 |
| video | | | lossless | |

The need to deliver low latency traffic as soon as possible to support RTA STAs stems from high delay negatively affecting the RTA traffic in current networks. For example, the ongoing PHY protocol data unit (PPDU) may reach its maximum duration, such as the aPPDUMaxTime lasts 5.484 ms. This could severely delay the earliest time the low latency traffic may be delivered if the RTA traffic does not successfully contend for the resource unit (RU).

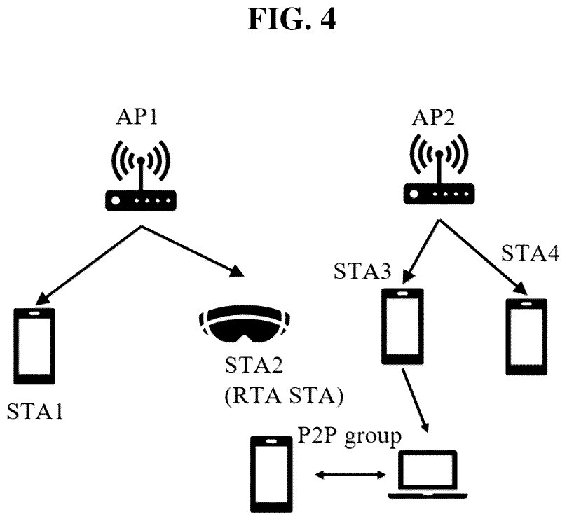

FIG. 4 shows an example multiple AP (MAP) network with a P2P group in accordance with an embodiment. The MAP network depicted in FIG. 4 is for explanatory and illustration purposes. FIG. 4 does not limit the scope of this disclosure to any particular implementation.

Referring to FIG. 4, the MAP network includes AP1 and AP2 which are coordinated. AP1 is the sharing AP. AP2 is the shared AP. Two STAs, STA1 and STA2, are associated with AP1. STA1 is a latency tolerant STA while STA2 is A low-latency (LL) STA or RTA STA. STA3 is associated with AP2. A peer-to-peer (P2P) group is nearby and one of the peer STA may also have P2P traffic with STA3. To reduce the latency for the RTA traffic, a dedicated RU specifically for LL may be allocated to STA2. AP1 may schedule a dedicated RU and/or piggybacked on the ongoing traffics with STA1.

One key issue is that the dedicated RUs may be occupied by other STAs which may not be aware of the reservation of the RUs for RTAs, when no signal is transmitted on the pre-determined RUs until the RTA traffic arrives in the buffer. Overlapping BSS (OBSS) STAs or P2P groups may occupy the dedicated RUs without knowledge of the reservation. With channel bonding and preamble puncturing, there is a chance that OBSS STAs may observe these RUs as idle and include them in their own transmissions. A P2P group may also be aware of the channel and make the channel a potential off-channel for channel switching. This is highly likely since typically BSS go out of synchronization, and perform inter-BSS backoff using energy detection instead of preamble detection. With energy detection, a neighboring BSS cannot set the network allocation vector (NAV) for the transmission and thus may take up the idle 20 MHz channel that was reserved.

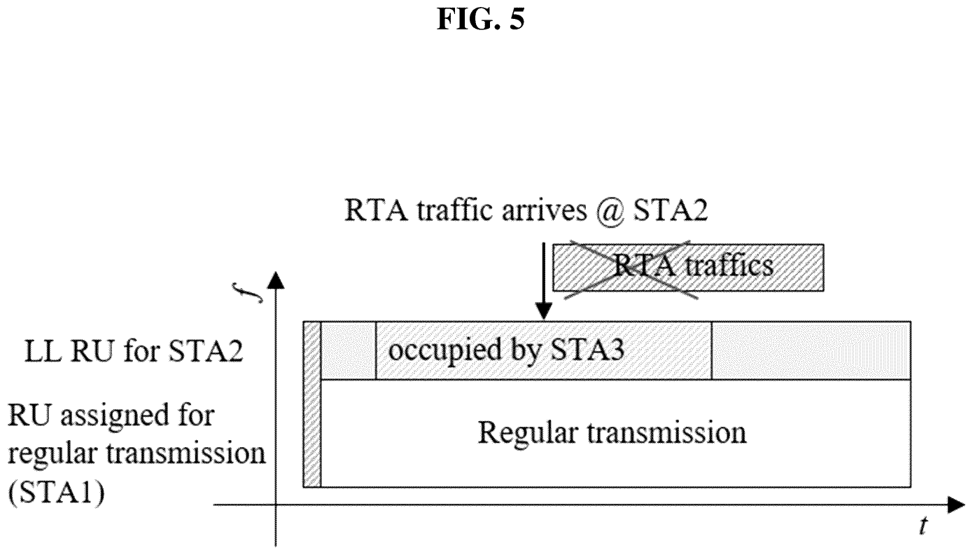

FIG. 5 shows an example scenario of an RU dedicated for RTA traffic being occupied by OBSS STAs when the RTA traffic arrives in accordance with an embodiment. The scenario depicted in FIG. 5 is for explanatory and illustration purposes. FIG. 5 does not limit the scope of this disclosure to any particular implementation.

Referring to FIG. 5, a time and frequency resource unit comprises RUs assigned for regular transmission in the lower half of the time and frequency resource unit and a dedicated RU reserved for RTA traffic in the top half of the time and frequency resource unit. The dedicated RU is occupied by OBSS STAs when the RTA traffic arrives resulting in latency for the RTA traffic.

Solutions are needed to protect the dedicated RU from OBSS STAs taking the dedicated RU from the RTA traffic.

A Wireless LAN network device, such as an AP, upon obtaining a channel resource, may reserve a portion of that bandwidth for transmission of low-latency traffic to RTA devices. This reservation may be used for transmitting to the RTA devices and/or for reception from the RTA devices. This portion of the bandwidth may be non-contiguous and may include multiple RUs which may be referred to as low-latency resource units (LL-RUs).

In an embodiment, the APs in the MAP architecture may also be non-collocated APs, in which one or more APs may be the logical entity.

In an embodiment, the sharing AP may be the coordinating AP to schedule the LL request, the shared AP can be the coordinated AP to respond to the LL request.

In an embodiment, the shared AP may be the coordinating AP to schedule the LL request, the sharing AP can be the coordinating AP to respond to the LL request.

In an embodiment, a coordinating AP that may schedule the LL request may transmit a notification or make an indication to the coordinated APs about the LL-RUs so that other coordinated APs and their BSSs may avoid using the LL-RUs.

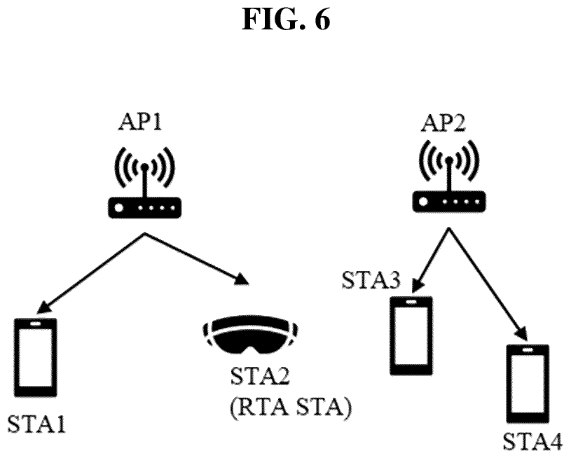

FIG. 6 shows an example multiple AP (MAP) network with an OBSS STA in accordance with an embodiment. The MAP network depicted in FIG. 6 is for explanatory and illustration purposes. FIG. 6 does not limit the scope of this disclosure to any particular implementation.

Referring to FIG. 6, the MAP network includes AP1 and AP2 which are coordinated. AP1 is the sharing AP. AP2 is the shared AP. Two STAs, STA1 and STA2, are associated with AP1. STA1 is a latency tolerant STA while STA2 is A low-latency (LL) STA or RTA STA. STA3 and STA4 are associated with AP2. STA3 and STA4 are OBSS STAs. STA2 may be reserved a dedicated RU for its LL traffic. Either STA3 or STA4 may occupy the dedicated RU if it is idle for too long.

In an embodiment, the coordinating AP may transmit a LL-RU request frame to the other coordinated APs. The LL-RU request frame may include the RU reserved for LL purpose, a reserved AID12 subfield of the User Info field for LL STA, and so on as shown in Table 2. The LL-RU may be a new reserved RU with a new association identifier (AID). It may also be an RU in which no STAs are assigned.

Table 2 shows Information items in the LL-RU request frame.

TABLE 2

| subfield | Description |
|---|---|
| LL-RU | Indicates a new RU that could be used only for latency sensitive |
| | purpose |
| User Info Field | Indicates which STA may use the LL-RU in the AID12 subfield, a |
| | reserved bit may be used for an RTA STA |
| LL-RU allocation | Indicates the RU that RTA STAs support and are assigned by the |
| | associated AP |
| RSSI or location | Indicates the location of the LL STA so that the coordinated AP may |
| | measure the interference between the coordinated AP (AP2) and the |
| | RTA STA (which is associated with AP1) |
| The starting time of | Indicates the starting time of the reserving the LL-RU |
| the LL traffics | |
| The duration of | Indicates the duration of reserving the LL-RU |
| holding the LL traffics | |

In an embodiment, the coordinating AP may have LL traffic and intend to transmit on the LL-RU to the RTA STA. In an embodiment, this AP may receive an LL request from the RTA STA. In an embodiment, the AP may indicate using the LL-RU in one or more TXOPs or service periods (SPs).

In the new LL-RU request frame, one or more of the above fields may be considered. The User Info List may include one or more of the RTA STAs with reserved AID12. The RU allocation may include the RU that the RTA STAs may support. The LL-RU request frame may also consider integrating one or more Elements from the stream classification service (SCS) frame, such as User Priority (UP) or intra-class Category Priority Element to show the priority of the traffic of the RTA STA.

In an embodiment, the main information elements of the LL-RU request frame, such as the LL information element, may be considered in a management frame such as beacons, probe frames and (re) association frames. In an embodiment, the information may be considered in control frames such as MU-RTS frames.

In an embodiment, the main information elements of the LL-RU request frame may be considered in part or as a whole of the SCS frame.

In an embodiment, the coordination of SCS frames among APs is where the SCS is a service that may be provided by an AP to its associated STAs that support SCS. In SCS, the AP classifies incoming individually addressed medium access control (MAC) service data units (MSDUs) based upon parameters provided by the non-AP STA. The coordination of a quality of service (QOS) element among APs may be transmitted via restricted-target wake time (R-TWT) or coordinated TWT. In the coordination SCS among APs, the coordinated-SCS (C-SCS) is a service that may be provided by one coordinating AP to the nearby coordinated APs who may support the C-SCS. In C-SCS, the coordinated AP classifies incoming individually addressed MSDUs based upon parameters provided by the coordinating APs. Additionally, the C-SCS includes information and parameters provided by the non-AP STAs associated with the coordinating AP.

In an embodiment, the TWT-based LL-RU protection may be considered. During the TWT SP, the LL-RU may be reserved for LL traffics. Reservation of the LL-RU may be provided by the trigger based TWT including a modified RARU specifically for LL traffics.

In an embodiment, a new SCS Descriptor element may have need for the QoS requirement between the coordinated AP and the coordinating AP, within which the C-SCS request and C-SCS response frames are exchanged and negotiated. In an embodiment, the BSSID of each of the BSSs with respect to the coordinated AP and coordinating APs may need to be included in the C-SCS frames, such as the C-SCS request frame and C-SCS response frame, which are variants of the SCS request frame and response frame. In an embodiment, the bits of the BSSID of the C-SCS may also be included in the SCS Descriptor List in the SCS request frame. A new Direction field of the Control Info field of the QoS Characteristics element of the SCS Descriptor element may include the uplink from coordinating AP to coordinated AP, downlink from coordinated AP to the coordinating AP, or direct link where MSDUs or A-MSDUs are sent over a peer-to-peer link, such as soft AP to soft AP.

In an embodiment, the C-SCS frames with the LL-RU among APs are defined. One or more information items in Table 2 may be included in the C-SCS frames. In an embodiment, the LL information may be included in the C-SCS request frame transmitting from the coordinating AP to the coordinated AP.

The LL information may be included in the QoS Characteristics element field, which may be included in SCS procedure or restricted TWT. In an embodiment, the LL information may be considered in the Control Info field of the QoS Characteristics Element field, where the reserved bit may be assigned to the LL-RU reserved for the RTA STA.

In an embodiment, the coordinating AP may transmit the request frame with the LL information element to each AP, and each coordinated AP may respond to the corresponding AP, where there are more than two APs. In an embodiment, the coordinated AP may broadcast a beacon with the LL information element to all the APs during the coordination phase.

A coordinating AP may transmit a request frame to the coordinated AP(s), in which the information may include the dedicated RU, AID, and time duration that the RTA STA may need, when the coordinating AP obtains a TXOP. After the coordinating AP has transmitted its request to the coordinated AP and the coordinated AP has transmitted its response to the coordinating AP reaching an agreement, the coordinated AP may take some action to notify its own BSS spreading the LL information request to other BSS. Particularly to the OBSS STAs which may have a chance to use the idle LL-RU if there is no indication that the RU is on hold.

In an embodiment, the coordinating AP may notify the coordinated APs of the presence of LL traffic implicitly or explicitly. For example, the coordinating AP may notify the coordinated APs of the RTA STA's LL traffic by indicating in the LL-RU request frame that there is LL traffic. The LL-RU request frame may be in the same channel as its associated AP or any primary channel or non-primary channel.

In an embodiment, when the coordinated AP, agrees to avoid using and prevent OBSS STAs from using an LL-RU, it may not have to notify its BSS by transmitting some frame, it may transmit a response frame with NAV setting. The response frame may be a clear-to-send (CTS) frame.

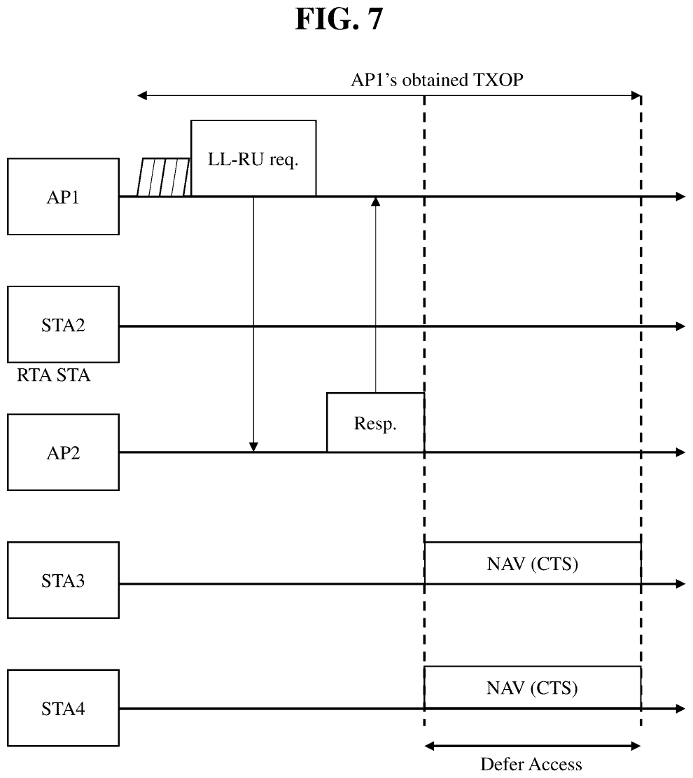

By responding to the coordinating AP, the coordinated AP(s) may need to set the NAV for its own BSS to protect the TXOP and LL-RU from being used. An example is shown in FIG. 7. In an embodiment, the response frame may be a CTS frame.

FIG. 7 shows an example frame exchange with an immediate response by a coordinating AP in accordance with an embodiment. The frame exchange depicted in FIG. 7 is for explanatory and illustration purposes. FIG. 7 does not limit the scope of this disclosure to any particular implementation.

Referring to FIG. 7, AP1 obtains TXOP on the wireless medium. Subsequently, AP1 transmits, to AP2, an LL-RU request frame (LL-RU req.) requesting that AP2 avoids using and prevents OBSS STAs from using an LL-RU. In some aspects, the LL-RU may be dedicated to STA 2 in the AP1's BSS. In response, AP2 transmits, to AP1, an LL-RU response frame (Resp.) indicating that AP2 accepts AP1's request. Subsequently, AP2 sets the NAV for its BSS so that STA3 and STA4 may not occupy the LL-RU reserved for STA2's LL traffic. In some aspects, the LL-RU response frame includes a duration field indicating duration information. Upon receiving the LL-RU response frame, STA 3 and STA 4 in the AP2's BSS may set or update their NAV timer based on the duration information indicated by the LL-RU response frame. The LL-RU response frame may be a CTS frame.

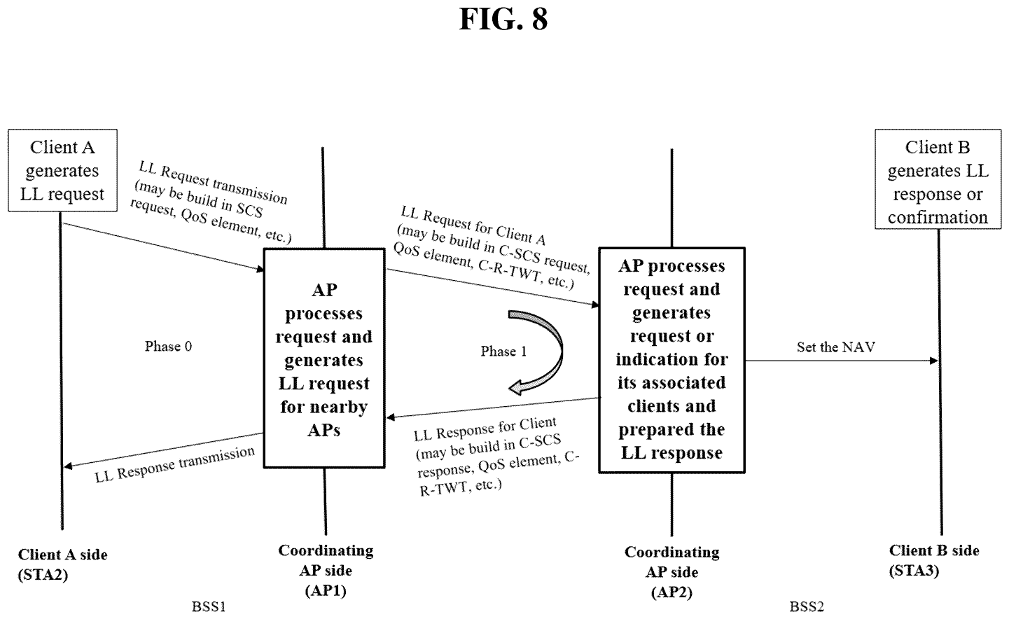

The flow handling among the clients and APs are shown in FIG. 8. Phase 0 is the negotiation phase in BSS1 in which Client A may transmit the LL request frame to its AP. In an embodiment, the AP may start the coordination among multiple APs. In an embodiment, the AP may reserve the LL-RU with preemption. If AP chooses to use the MAP method, then Phase 1 is considered.

FIG. 8 shows an example of flow handling using NAV in accordance with an embodiment. The flow handling depicted in FIG. 8 is for explanatory and illustration purposes. FIG. 8 does not limit the scope of this disclosure to any particular implementation.

Referring to FIG. 8, there are two STAs, STA2 (Client A) and STA3 (Client B), and two APs, AP1 and AP2. STA2 is the RTA STA with an LL transmission. STA2 is associated with AP1 and STA3 is associated with AP2. AP1 is a coordinating AP and AP2 is a coordinated AP. There are two Phases, Phase 0 and Phase 1.

In Phase 0, there is a negotiation between STA2 and AP1 for STA2's request for LL transmission. STA2 transmits, to AP1, a first LL request frame (LL request transmission) requesting that AP1 supports STA2's LL transmission. The LL request frame may be, for example, a stream classification service (SCS) request or a quality of service (QOS) element. AP1 processes the LL request from STA2 and enters Phase 1 to request that nearby APs prevent OBSS STAs from using the LL-RU reserved for STA2's LL transmission. After AP1 had conducted Phase 1, AP1 transmits, to STA2, a first LL response frame (LL Response transmission) indicating that AP1 accepts STA2's LL request.

In Phase 1, there is a negotiation between AP1 and AP2. There may be more than one coordinated AP. AP1 transmits, to AP2, a second LL request frame (LL Request for Client A) requesting that AP2 agrees to avoid using and prevent OBSS STAs from using the LL-RU for the LL Request of Phase 0. The second LL request frame may be in the form of, for example, a coordinated SCS (C-SCS) request, an QoS element or a coordinated restricted target wake time (C-R-TWT). In response, AP2 sets the NAV value for STA3 to prevent STA3 from using the LL-RU for a set duration associated with the second LL request frame. Subsequently, AP2 transmits, to AP1, a second LL response frame (LL Response for Client) indicating that AP2 accepts AP1's request. The second LL response frame may be in the form of a C-SCS response, QoS element or C-R-TWT. The AP2 may set the NAV value for STA3 by a third LL request frame or an indication frame. STA3 may transmit, to AP2, a third LL response frame or a confirmation frame in response to the third LL request frame or indication frame.

In an embodiment, the coordinated AP may not schedule any traffic on the LL-RU for any STAs in the following TXOP or SPs suggested in the LL request frames. The coordinated AP in its LL response to the LL request frame has made a commitment to avoid using and prevent OBSS STAs from using the LL-RU.

In an embodiment, the coordinated AP may also notify the associated STAs to avoid taking the LL-RU by transmitting a LL indication frame. The indication frame may include one or more of the information items described above, such as those in Table 2. In an embodiment, the LL-RU indication frame may include the BSSIDs from the coordinated BSS, and the AID of the RTA STA, such as STA2, so that the STAs associated with AP2 may be aware of the RTA STA with the LL request.

In an embodiment, the STAs associated with the coordinated AP may respond to the request. The coordinated AP may transmit a response to the requested or coordinating (coordinating) AP about the reception of the LL-RU request frame. The response frame may contain information such as an ACCEPT or DECLINE for the status code. The response frame with an ACCEPT or AGREE indicates the STA is aware of one or more of information such as the LL-RU, the AID of the RTA STA or the location of the RTA STA.

In an embodiment, the coordinated AP may transmit an immediate response to the coordinating AP about the reception of the LL-RU request frame. The immediate response frame may include information such as an ACCEPT or DECLINE for the status code. The response frame with an ACCEPT or AGREE indicates the coordinated AP is aware of one or more of the information such as the LL-RU, the ID of the RTA STA or the location of the RTA STA. The response frame with a code DECLINE indicates that the coordinated AP may not be willing to accept the coordinating AP's request. The reasons may be that the coordinated AP will also use the same RU for another purpose during the next or coming service period for one or more of the OBSS STAs or legacy STAs in its BSS, or the coordinated AP has not set up a coordination with coordinating AP and does not recognize the frame, or the coordinated AP cannot guarantee that all the associated STAs may also commit to this request. The coordinated AP may not have to guarantee that all associated STAs are prevented from using the LL-RU.

In an embodiment, the coordinated AP may guarantee to avoid by scheduling a different time/frequency resource accordingly. The coordinated AP may perform a channel switch or coordinated spatial reuse (CSR) on the RU if needed.

In an embodiment, the coordinated AP may transmit a delayed response frame to the coordinating AP. The delayed response frame may include information such as DELAY or HOLDING or PENDING for the status code. The delayed response may provide an estimated time for negotiation or notification among the coordinated AP and its associated STAs. Within the holding period indicated in the response frame for holding, the coordinated AP may check with its associated STAs to confirm the LL request. The coordinated AP may confirm and process with its associated STAs about the request and then response to the coordinating AP.

The coordinated AP may guarantee or provide that its associated STAs may not use the LL-RU in this embodiment.

The coordinated AP may make an immediate response in Phase 1 when the coordinating AP coordinates with the coordinated AP about information of the LL-RU that will be used. The coordination between the coordinating AP and the coordinated AP in Phase 1 may occur periodically or a-periodically. The coordinated AP may broadcast the RU that will be used for LL traffic purpose. In an embodiment, the coordinated AP may also inform STA3 of the LL-RU reserved by coordinating AP for RTA STA.

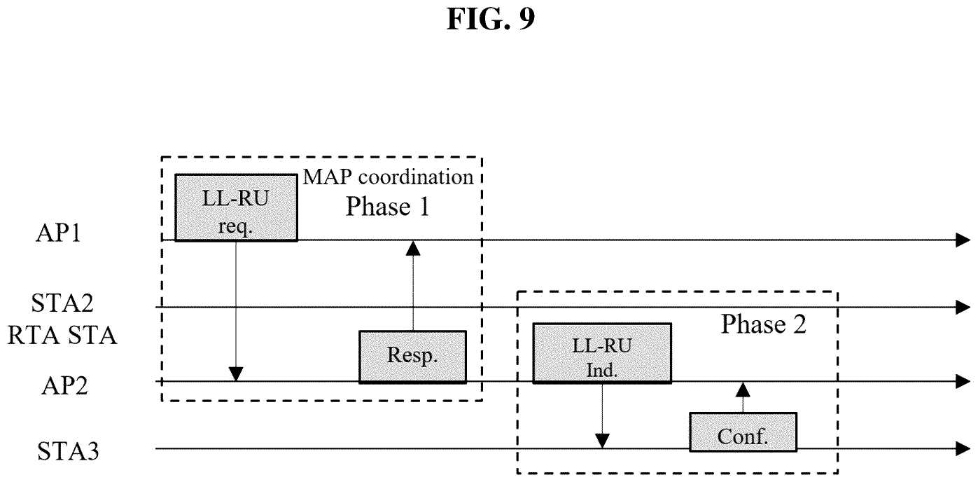

FIG. 9 shows an example frame exchange with an immediate response by the coordinated AP in accordance with an embodiment. The frame exchange depicted in FIG. 9 is for explanatory and illustration purposes. FIG. 9 does not limit the scope of this disclosure to any particular implementation.

Referring to FIG. 9, AP 1 and AP 2 are participating in a multi-AP (MAP) coordination. AP1 is the coordinating AP and AP2 is the coordinated AP. AP1 is associated with STA2 which is an RTA STA. AP2 is associated with STA3 which is an OBSS STA.

In Phase 1, AP1 transmits, to AP2, an LL-RU request frame (LL-RU req.) requesting that AP2 avoids using and prevents OBSS STAs from using an LL-RU, identifying the LL-RU for the transmission. In response, AP2 transmits, to AP1, a response frame (Resp.) indicating that AP2 accepts AP1's request.

In Phase 2, subsequently, AP2 transmits an LL-RU indication frame (LL-RU Ind.) to STA3 in AP 2's BSS, requesting that STA 3 avoid using the LL-RU identified in the LL-RU indication frame. In response, STA3 transmits, to AP2, a confirmation frame (Conf.) of AP2's request.

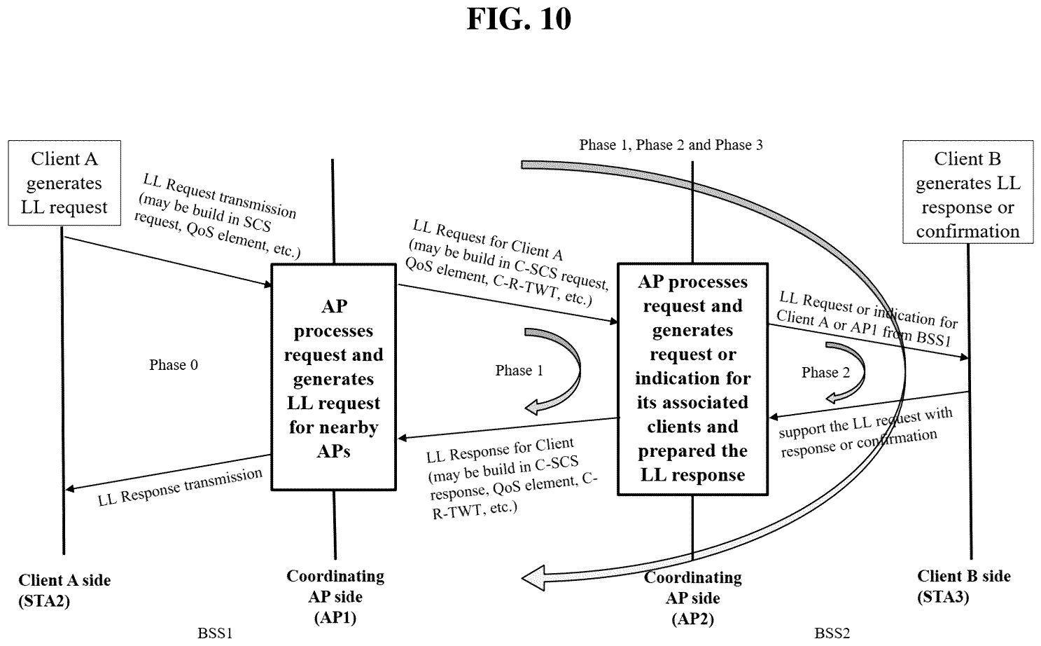

The flow handling among the clients and APs is shown in FIG. 10. Phase 0 is the negotiation phase in BSS1 in which Client A (STA2) may transmit the LL request frame to the coordinating AP (AP1). In an embodiment, AP1 may start the coordination among multiple APs. In another embodiment, AP1 may reserve the LL-RU with preemption. AP1 may enter Phase 1 when AP1 chooses to use the MAP method described below. Similarly, a coordinating AP (AP2) may enter Phase 2 after receiving an LL request frame from AP1 when AP2 accepts AP1's LL request.

FIG. 10 shows an example of flow handling using an LL request or indication in accordance with an embodiment. The flow handling depicted in FIG. 10 is for explanatory and illustration purposes. FIG. 10 does not limit the scope of this disclosure to any particular implementation.

Referring to FIG. 10, there are two STAs, STA2 (Client A) and STA3 (Client B), and two APs, AP1 and AP2. STA2 is the RTA STA with an LL transmission. STA3 is associated with AP2. STA2 and AP1 form BSS1 and STA3 and AP2 form BSS2. AP1 is a coordinating AP and AP2 is a coordinated AP. There are three Phases, Phase 0, Phase 1 and Phase 2.

In Phase 0, there is a negotiation between STA2 and AP1 for STA2's request for LL transmission. STA2 transmits, to AP1, a first LL request frame (LL request transmission) requesting that AP1 supports STA2's LL transmission. The first LL request frame may be in the form of, for example, an SCS request or an QoS element. AP1 processes the LL request from STA2 and enters Phase 1 to request that nearby APs prevent OBSS STAs from using the LL-RU reserved for STA2's LL transmission. After AP1 has conducted Phase 1, AP1 transmits, to STA2, a first LL response frame (LL Response transmission) indicating that AP1 accepts STA2's LL request.

In Phase 1, there is a negotiation between AP1 and AP2. There may be more than one coordinated AP. AP1 transmits, to AP2, a second LL request frame (LL Request for Client A) requesting that AP2 avoids using and prevents OBSS STAs from using an LL-RU. The second LL request frame may be in the form of, for example, a C-SCS request, an QoS element or an C-RTWT. In response, AP2 enters Phase 2 to request that STA3 not use the LL-RU. After AP2 has conducted Phase 2, AP2 transmits, to AP1, a second LL response frame (LL Response for Client) indicating that AP2 accepts AP1's request. The second LL response frame may be in the form of, for example, an C-SCS response, an QoS element or an C-R-TWT.

In Phase 2, the AP2 transmits, to STA3, a third LL request frame or an indication frame for STA2 or AP1 from BSS1 requesting that STA 3 avoid using the LL-RU identified in the third request frame or indication frame. In response, STA3 transmits, to AP2, an LL response frame agreeing to not use the LL-RU for STA2. STA3 may instead transmit, to AP2, a confirmation frame agreeing not to use the LL-RU.

The LL-RU reservation or protection may be set as a long-term reservation or protection, such as setting an RU as an LL-RU specific. Operations for non-LL traffic may exclude that RU by information indicating non-use, such as where a bit in the Disabled Subchannel Bitmap subfield bitmap is set to 1 to indicate the LL-RU is punctured.

In an embodiment, the coordinated AP may respond to the coordinating AP after the Phase 2 is complete. Then a third phase, Phase 3 or a pending Phase 1 is considered. The coordinating AP may transmit the LL-RU prompting the coordinated AP to respond to the coordinating AP with the delayed response, in which the coordinated AP agrees to support STA2's LL transmission. When STA3 responds with an acceptance to the coordinated AP on the LL-RU indication, the coordinated AP then responds with an acceptance to the coordinating AP. The flow handling for this embodiment is shown in FIG. 10 in which Phase 1, Phase 2, and Phase 3 are included as shown in the example of FIG. 10.

In an embodiment, the delayed response frame or response frame with holding requirement in Phase 1 is transmitted. The delayed response frame may include information such as DELAY or HOLDING or PENDING for the status code. The delayed response frame may include the configuration timeout, the maximum time that the coordinating AP needs before receiving the response frame. Otherwise, a retransmission may be needed. The retransmission time may also be limited. The frame may extend the expired time of the response frame for the coordinating AP.

In an embodiment, the delayed response frame may also be an ACK frame which indicates an extension of waiting or delaying for the response to the coordinating AP, or an implicit ACK building in the PHY header of LL-RU indication frame. Once the coordinating AP receives the delayed response frame, including explicit ACK or implicit ACK, the coordinating AP will extend the expired time for receiving the response frame.

In an embodiment, the response frame in Phase 3 is transmitted. This response frame may provide the finalized decision from a coordinated AP and its associated STAs that may avoid using the LL-RU as requested by the coordinating AP. The information items such as those in Table 2 may be considered. If there are multiple STAs or multiple coordinated APs that agree to avoid using the LL-RU, multiple User Info List is needed. In an embodiment, the response frame may also include STAs and APs who may not be able to support information, such as the AID of the user or the reason code.

In an embodiment, the coordinating AP may just request the OBSS STA to avoid using the LL-RU, interfering with the resources needed for LL requirements of the coordinating AP's BSS. The request and response frame may only include the information of the OBSS STA, such as STA3. The information may include one or more items such as the AID of the STA, BSSID of the STA or the RSSI.

In one embodiment, the LL-RU confirmation frame is transmitted. This confirmation frame from the coordinated AP to coordinating AP may confirm the information about the supported STAs and coordinated APs.

In an embodiment based on the current stage of 11bn, the coordination among APs could also occur in backhaul in which the Phase 1 and Phase 3 may happen via wire. However, the negotiation among the coordinated AP and its associated STAs need to be performed wirelessly.

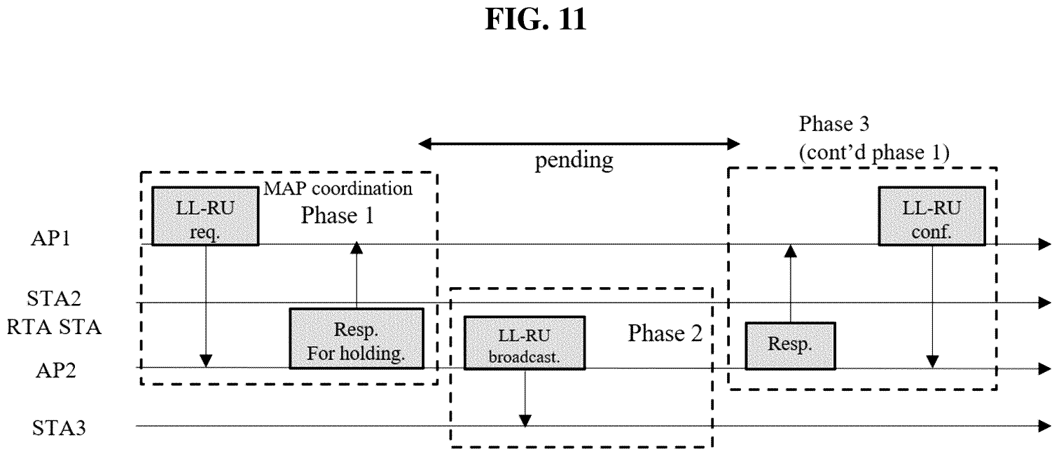

FIG. 11 shows an example frame exchange with a delayed response by the coordinated AP in accordance with an embodiment. The frame exchange depicted in FIG. 11 is for explanatory and illustration purposes. FIG. 11 does not limit the scope of this disclosure to any particular implementation.

Referring to FIG. 11, AP 1 and AP 2 are participating in an MAP coordination. AP1 is the coordinating AP and AP2 is the coordinated AP. AP1 is associated with STA2 which is an RTA STA. AP2 is associated with STA3 which is an OBSS STA.

In Phase 1, AP1 transmits, to AP2, a LL-RU request frame (LL-RU req.) requesting that AP2 avoids using an LL-RU and prevents OBSS STAs from using the LL-RU, identifying the LL-RU for the transmission. In response, AP2 transmits, to AP1, a response frame (Resp. For holding) indicating AP2 does not decline the request but requires a period of time to respond. The response frame may include a period of time for AP2 to respond by.

In Phase 2, AP2 transmits, to STA3, an LL-RU broadcast frame (LL-RU broadcast.) indicating that the LL-RU identified in the LL-RU request is to be avoided by STA3. Phase 2 may end without AP2 transmitting an LL broadcast frame at the expiration of the period of time indicated in Phase 1.

In Phase 3, which is a continuation of Phase 1, AP2 transmits, to AP1, a response frame (Resp.) indicating that AP2 agrees to avoid using the LL-RU and prevent OBSS STAs from using the LL-RU. In response, AP1 transmits, to AP2, a LL-RU confirmation frame (LL-RU conf.).

In an embodiment, the coordinated AP and the coordinating AP may share the dedicated LL-RU information for RTA STAs among their BSSs. In such a case, the LL STAs may take advantage of multiple LL-RUS.

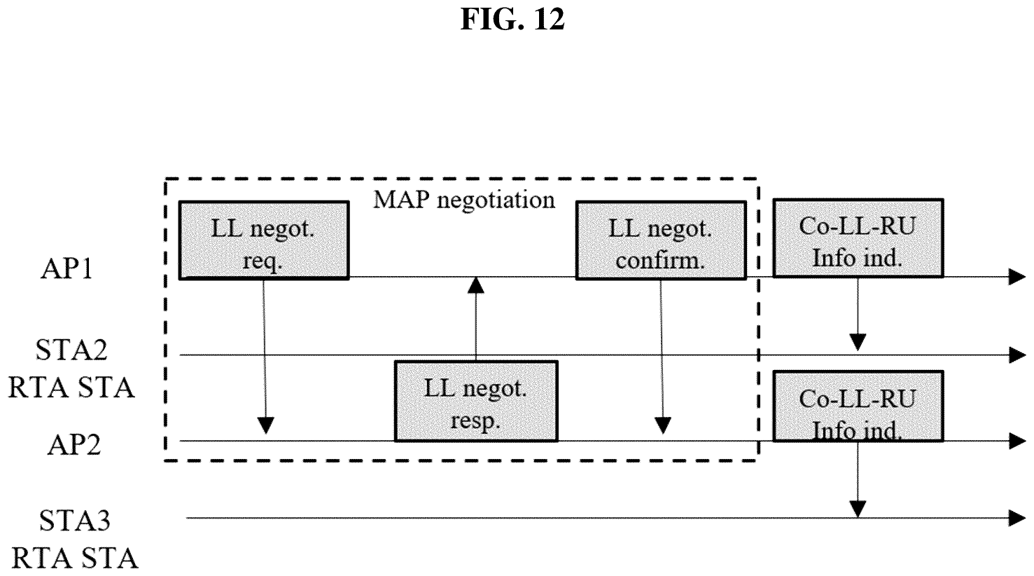

In an embodiment, the coordinated AP and the coordinating AP may perform a negotiation procedure including the LL-RU information sharing. In FIG. 6, STA3 may also be an RTA STA. If STA3 is an RTA STA, then AP1 and AP2 may negotiate the LL-RU information based on the needs in their BSSs and each BSS will respect the others. For example, AP1 allocates RUI to STA2 (RTA STA), and AP2 allocates RU2 to STA3 (RTA STA). Both APs share the information and are aware of the LL-RUs. An example of the frame exchange can be considered in FIG. 12. AP1 has the LL request from its own BSS, and transmits an LL-RU request frame to AP2. AP2 also has the LL requirement, thus it responds to AP1 and adds its own LL requirement in the response frame. AP1 receives the LL-RU response frame and confirms the coordination.

FIG. 12 shows an example frame exchange between two APs with LL traffic in their respective BSSs in accordance with an embodiment. The frame exchange depicted in FIG. 12 is for explanatory and illustration purposes. FIG. 12 does not limit the scope of this disclosure to any particular implementation.

Referring to FIG. 12, AP 1 and AP 2 are participating in an MAP negotiation. AP1 is the coordinating AP and AP2 is the coordinated AP. AP1 is associated with STA2 which is an RTA STA. AP2 is associated with STA3 which is an RTA STA.

In the MAP negotiation, AP1 transmits, to AP2, an LL negotiation request frame (LL negot. req.) requesting that AP2 avoids using and prevents OBSS STAs from using an LL-RU for STA2. In response, AP2 transmits, to AP1, an LL negotiation response frame (LL negot. resp.) indicating that AP2 agrees to avoid using and prevent OBSS STAs from using the LL-RU for STA2 and STA3's LL requirement. In response, AP1 transmits, to AP2, an LL negotiation confirmation frame (LL negot. confirm.) indicating that AP1 agrees to avoid using and prevent OBSS STAs from using an LL-RU for STA3.

After conclusion of the MAP negotiation, AP1 transmits, to STA2, a coordinated LL-RU Info indication frame (Co-LL-RU Info ind.) indicating that AP1 agrees to support STA2's LL transmission and the existence of STA3's LL requirements. AP2 transmits, to STA3, a coordinated LL-RU Info indication frame (Co-LL-RU Info ind.) indicating that AP2 agrees to support STA3's LL transmission and the existence of STA2's LL requirement.

In an embodiment, the coordinating AP may transmit an LL negotiation request frame to the other coordinated APs. The LL-RU request frame may include the RU reserved for LL purpose, similar to that shown in Table 2. In an embodiment, the LL negotiation request frame may also contain some information items shown in Table 3. For example, the User Priority (UP), preemption capability or preemption enabled field.

TABLE 3

| subfield | Description |
|---|---|
| Operating LL RU | The information items may include a preferred operating LL |
| | resource unit or channel |
| LL RU lists | Indicate the LL-RU that the RTA STA and its associated AP can |
| | support as base and off-channels |
| User priority | This is to indicate the UP of MSDUs or A-MSDUs of the stream, |
| | it may contain several values from lowest to highest |
| Preemption capability | This is to indicate if the LL-RU has the preemption capability, a |
| | bit 1 indicates capable for preemption, a bit 0 indicates unable for |
| | preemption |
| Preemption enabled | This is to indicate if the LL-RU allows preemption. A bit 1 |
| | indicates allowing preemption within the TXOP or SP, a bit 0 |
| | indicates preemption disallowed within the TXOP or SP |

In an embodiment, the coordinated AP may respond to AP1 in the LL negotiation response frame. The LL negotiation response frame may also include the information in Table 3, and thus the APs may compare the UP and assign the LL-RU to the most urgent traffic. If the UPs from different BSS are the same, contention-based or preemption may be considered when the LL-RU and the LL TXOP are fully overlapped.

In an embodiment, the coordinated AP and coordinating AP may choose a common RU as the LL-RU purpose, and the coordinated AP may select the RU from the LL RU lists and use that as a common LL-RU.

In an embodiment, a confirmation negotiation frame from the coordinating AP to coordinated AP is to confirm the UP and preemption capability, RU information or common RU as shown in Table 3.

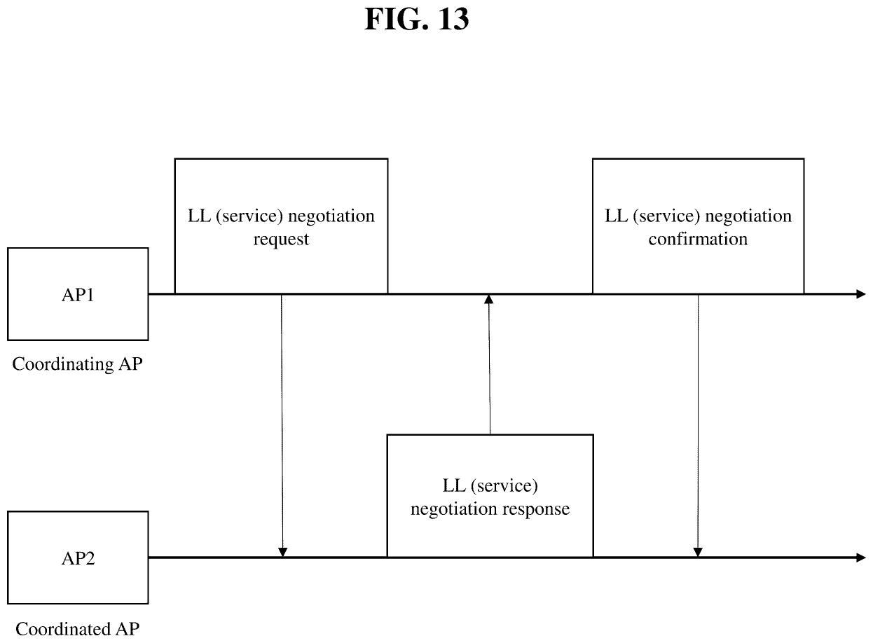

FIG. 13 shows an example LL negotiation procedure between a coordinating AP and a coordinated AP in accordance with an embodiment. The negotiation procedure depicted in FIG. 13 is for explanatory and illustration purposes. FIG. 13 does not limit the scope of this disclosure to any particular implementation.

Referring to FIGS. 13, AP1 and AP2 are engaged in MAP negotiation. AP1 is the coordinating AP and AP2 is the coordinated AP. AP1 and AP2 have BSSs with LL requirements. AP1 transmits, to AP2, an LL negotiation request frame (LL (service) negotiation request) requesting that AP2 avoids using and prevents OBSS STAS from using an LL-RU that AP1 determined to use for the LL requirements of its BSS. The LL negotiation request frame may include information indicating the operating LL RU, LL RU lists, user priority and preemption capability. The operating LL RU is the LL-RU used for the LL requirements of AP1's BSS. The LL RU lists include a number of LL-RUs that may be used for LL requirements. The user priority indicates the priority of the AP1's BSS on the LL-RU. The preemption capability indicates that preemption is possible on the LL-RU. In response, AP2 transmits, to AP1, a LL negotiation response frame (LL (service) negotiation response) accepting AP1's request and indicating that AP2 has need for an LL-RU for the LL requirements of its BSS. The LL negotiation response frame may include the operating LL RU, LL RU lists, user priority and preemption capability which carry the same information as described for the LL negotiation request frame. In response, AP1 transmits, to AP2, an LL negotiation confirmation frame accepting AP2's response. Through this negotiation, AP1 and AP2 agree to coordinate so the STAs of both BSSs do not interfere with the LL Requirements of the other BSS.

In an embodiment, the information in the LL negotiation procedure may also be embedded in the SCS request and response frames from APs. In an embodiment, the information may also be embedded in the coordinated target wake time (TWT) procedure, within which the duration, starting time or service period (SP) may also be considered and negotiated.

In an embodiment, after the negotiation procedure among APs, the coordinating and coordinated APs may notify their associated STAs as well as the RTA STAs about the LL-RU and negotiation results, such as the LL-RUs, the UP or the preemption capability, via the Coordinated LL-RU information indication frame. There may be many cases and results from the negotiation procedures.

In an embodiment, the coordinating AP and the coordinated AP from different BSSs may avoid transmission in the dedicated RUs in the scheduled time. For example, the coordinated AP may reschedule the RU or TXOP for its STAs if there is a conflict. In another example, the coordinating AP may reschedule the RU or TXOP for its STAs if there is a conflict and indicating in the confirmation frame.

In an embodiment, the negotiation procedure indicates RTA STAs from different BSSs may exist in different LL-RUs and different TXOPs. In such a case, there is no conflict among the RTA STAs.

In an embodiment, the negotiation procedure indicates RTA STAs from different BSSs may exist in the same LL-RU but different TXOPs. In such a case, there is no conflict among the RTA STAs.

In an embodiment, the negotiation procedure indicates that the RTA STAs from different BSSs may exist in different LL-RUs but the same TXOP. The RTA STAs may use the assigned LL-RUs without any conflict. In an embodiment, the LL STA may use their own or both if no RTA STA is detected in the coordinated LL-RUs to maximize the efficiency of the utilization.

In an embodiment, the negotiation procedure indicates that the RTA STAs from different BSSs may exist in the same LL-RUs and the same TXOP. In an embodiment, the contention-based channel access may be considered when the UPs of the RTA STAs are same. In an embodiment, preemption may be considered. For example, the RTA STA with higher UP may preempt the RTA STA with lower UP.

In an embodiment, a representative STA or group owner (GO) in a P2P group which is associated with a coordinated AP may deliver the LL information considered above to the P2P group.

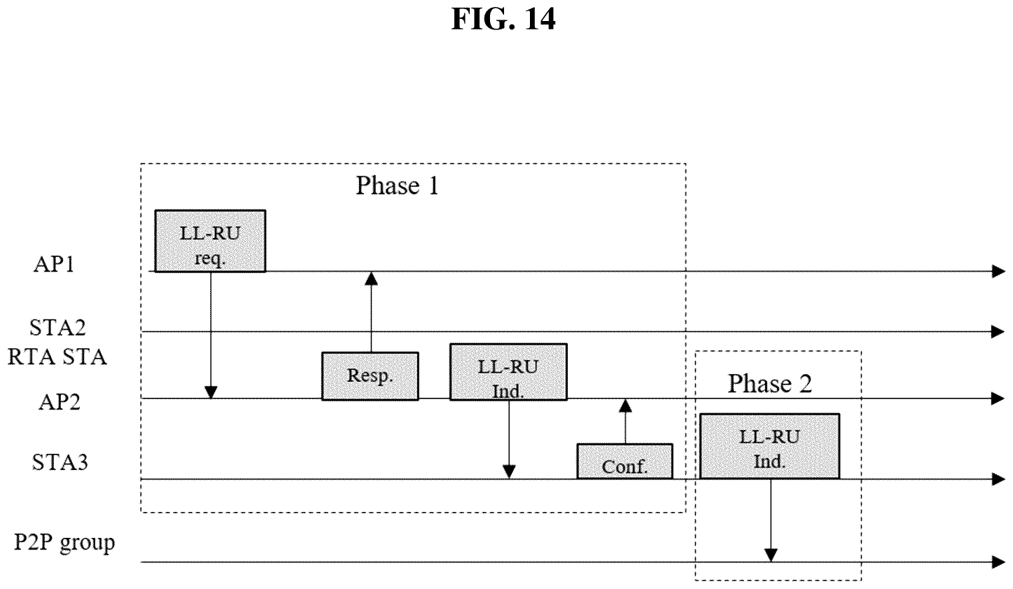

FIG. 14 shows an example frame exchange indicating LL information to a P2P group in accordance with an embodiment. The frame exchange depicted in FIG. 14 is for explanatory and illustration purposes. FIG. 14 does not limit the scope of this disclosure to any particular implementation.

Referring to FIG. 14, AP 1 and AP 2 are participating in an MAP coordination. AP1 is the coordinating AP and AP2 is the coordinated AP. AP1 is associated with STA2 which is an RTA STA. AP2 is associated with STA3 which is a representative STA or GO in a P2P group.

In Phase 1, AP1 transmits, to AP2, an LL-RU request frame (LL-RU req.) requesting that AP2 avoids using and prevents OBSS STAs from using an LL-RU for STA2. In response, AP2 transmits, to AP1, a response frame (Resp.) agreeing to avoid using and prevent OBSS STAs from using the LL-RU for STA2. Subsequently, AP2 transmits, to STA3, an LL-RU Indication frame (LL-RU Ind.) indicating LL information associated with AP1's request. In response, STA3 transmits, to AP2, a confirmation frame (Conf.) confirming receipt of the LL information.

In Phase 2, STA3 transmits, to the P2P group, an LL-RU Indication frame (LL-RU Ind.) indicating the LL information associated with AP1's request. The LL information may include identification of the LL-RU and a period of time for which the STAs of the P2P group are to avoid using the LL-RU.

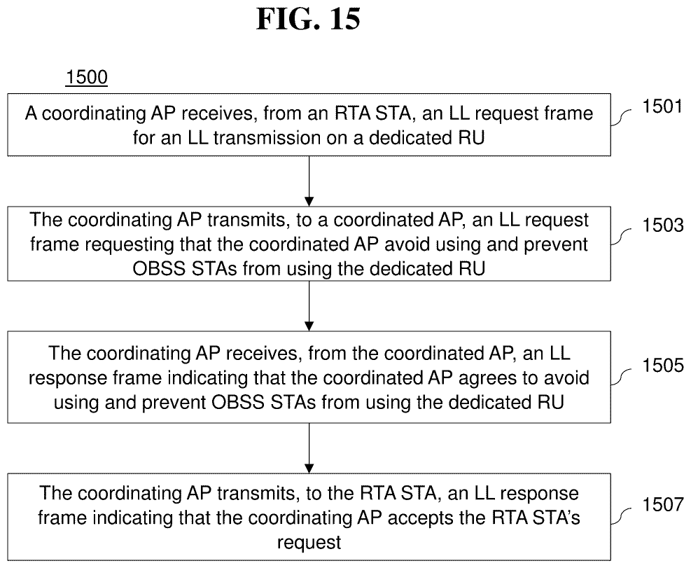

FIG. 15 shows an example process for a coordinating AP-side negotiation procedure in accordance with an embodiment. The process depicted in FIG. 15 is for explanatory and illustration purposes. FIG. 15 does not limit the scope of this disclosure to any particular implementation.

Referring to FIG. 15, the process 1500 begins at operation 1501. In operation 1501, a coordinating AP receives, from an RTA STA, an LL-RU request frame for an LL transmission on a dedicated RU. There may be more than one dedicated RUs for LL traffic.

In operation 1503, the coordinating AP transmits, to a coordinated AP, an LL-RU request frame requesting that the coordinated AP avoid using and prevent OBSS STAs from using a dedicated RU for an RTA STA. The coordinated AP is an AP associated with a BSS including STAs that may occupy the dedicated RU. The coordinating AP's request frame may include dedicated LL-RU information. The coordinating AP may transmit an LL-RU negotiation request frame instead, indicating information items of the operating LL-RU.

In operation 1505, the coordinating AP receives, from the coordinated AP, an LL-RU response frame indicating that the coordinated AP agrees to avoid using and prevent OBSS STAs from using the dedicated RU for the RTA STA. The coordinated AP may comply with the coordinating AP's request by setting a NAV for STAs in its BSS or by requesting that the STAs avoid the dedicated RU. If the coordinating AP transmitted an LL-RU negotiation request frame, then the coordinating AP may receive an LL-RU negotiation response frame. Additionally, the LL-RU negotiation response frame may indicate that the coordinated AP has LL requirements in its BSS as well and the coordinating AP will respond with a confirmation frame accordingly.

In operation 1507, the coordinating AP transmits, to the RTA STA, a LL response frame indicating that the coordinating AP accepts the RTA STA's request. The coordinating AP may include dedicated LL-RU information.

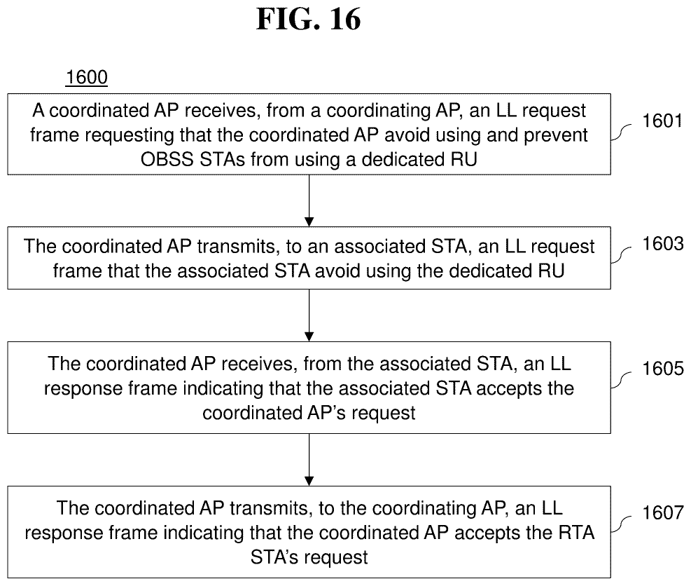

FIG. 16 shows an example process for a coordinated AP-side negotiation procedure in accordance with an embodiment. The process depicted in FIG. 16 is for explanatory and illustration purposes. FIG. 16 does not limit the scope of this disclosure to any particular implementation.

Referring to FIG. 16, the process 1600 begins at operation 1601. In operation 1601, a coordinated AP receives, from a coordinating AP, an LL-RU request frame requesting that the coordinated AP avoid using and prevent OBSS STAs from using a dedicated RU. The LL-RU request frame may include dedicated LL-RU information. The coordinated AP may instead receive an LL-RU negotiation request frame.

In operation 1603, the coordinated AP transmits, to an associated STA, an LL-RU request frame requesting that the associated STA avoid using the dedicated RU. The coordinated AP may instead transmit an LL-RU indication frame conferring the same dedicated LL-RU information. The coordinated AP may set a NAV for the associated STA so that the associated STA avoids the dedicated LL-RU or indicate information about the dedicated LL-RU, so the associated STA avoids the dedicated LL-RU.

In operation 1605, the coordinated AP receives, from the associated STA, an LL-RU response frame indicating that the associated STA agrees to avoid using the dedicated RU. The coordinated AP may instead receive a confirmation frame confirming that the associated STA received the coordinated AP's request. The LL-RU response frame may indicate that the associated STA had LL requirements, or the coordinated AP may already know about LL requirements in the BSS.

In operation 1607, the coordinated AP transmits, to the coordinating AP, an LL-RU response frame indicating that the coordinated AP accepts the RTA STA's request. The coordinated AP may transmit an LL-RU negotiation response frame instead and receive a confirmation frame from the coordinating AP. Additionally the LL-RU negotiation response frame may indicate that the coordinated AP has LL requirements and provide LL information to the coordinating AP.

The disclosure provides mechanisms and procedures for negotiation in a MAP network for dedicated RU protection, such as a coordinating AP coordinating with a coordinated AP so that the coordinated AP's BSS doesn't occupy the LL-RU that an RTA STA associated with the coordinating AP would use.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of”' does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in a different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point (AP) for facilitating communication in a wireless network, comprising:
a memory;
a processor coupled to the memory, the processor configured to cause:
receiving, from a second AP, a first request frame requesting coordination so that the first AP and one or more stations (STAs) in a basic service set (BSS) of the first AP avoid using a first resource unit (RU), wherein the first RU is dedicated for low-latency traffic transmission and the first request frame includes a first duration for the coordination; and
transmitting, to the second AP, a first response frame accepting the request of the first request frame.

2. The first AP of claim 1, wherein the first request frame includes an identification for a STA designated to use the first RU for low-latency traffic transmission.

3. The first AP of claim 1, wherein:
the first request frame is a stream classification service (SCS) request frame including classification information and parameters provided by one or more STAs associated with the first AP; and
the first response frame is an SCS response frame.

4. The first AP of claim 1, wherein the processor is further configured to cause:
transmitting, to the second AP, a third request frame requesting coordination so that the second AP and one or more STAs in a BSS of the second AP avoid using a second RU, wherein the second RU is dedicated for low-latency traffic transmission; and
receiving, from the second AP, a fourth response frame accepting the request of the third request frame.

5. The first AP of claim 1, wherein the processor is further configured to cause:
transmitting, to the one or more STAs, a second request frame requesting that the one or more STAs avoid using the first RU for the first duration; and
receiving, from at least one of the one or more STAs, a second response frame accepting the request of the second request frame.

6. The first AP of claim 5, wherein the first response frame includes a second duration for setting a network allocation vector (NAV) in the BSS of the first AP, the second duration being determined based on the first duration.

7. The first AP of claim 5, wherein the processor is further configured to cause:
transmitting, to the second AP, a third response frame deferring acceptance of the first request frame for a period of time in response to the first request frame;
performing communication with the one or more STAs; and
transmitting, to the second AP, the first response frame accepting the request of the first request frame.

8. The first AP of claim 1, wherein the first request frame includes information indicating a presence of low-latency traffic on the first RU.

9. A first access point (AP) for facilitating communication in a wireless network, comprising:
a memory;
a processor coupled to the memory, the processor configured to cause:
transmitting, to a second AP, a first request frame requesting coordination so that the second AP and one or more stations (STAs) in a basic service set (BSS) of the second AP avoid using a first resource unit (RU), wherein the first RU is dedicated for low-latency traffic transmission; and
receiving, from the second AP, a first response frame accepting the request of the first request frame.

10. The first AP of claim 9, wherein the first request frame includes an identification for a STA designated to use the first RU for low-latency traffic transmission.

11. The first AP of claim 9, wherein:
the first request frame is a stream classification service (SCS) request frame including classification information and parameters provided by one or more STAs associated with the first AP; and
the first response frame is an SCS response frame.

12. The first AP of claim 9, wherein the processor is further configured to cause:
receiving, from the second AP, a second request frame requesting coordination so that the first AP and one or more STAs in a BSS of the first AP avoid using a second RU, wherein the second RU is dedicated for low-latency traffic transmission; and
transmitting, to the second AP, a second response frame accepting the request of the second request frame.

13. The first AP of claim 12, wherein the processor is further configured to cause:
transmitting, to the one or more STAs, a frame indicating information associated with the second RU.

14. The first AP of claim 9, wherein the processor is further configured to cause:
receiving, from a STA associated with the first AP, a third request frame requesting an RU for a low-latency traffic transmission; and
transmitting, to the STA associated with the first AP, a third response frame accepting the third request and allocating the first RU.

15. The first AP of claim 9, wherein the first request frame includes information indicating a presence of low-latency traffic on the first RU.

16. A method performed by a first access point (AP) in a wireless network; the method comprising:
receiving, from a second AP, a first request frame requesting coordination so that the first AP and one or more stations (STAs) in a basic service set (BSS) of the first AP avoid using a first resource unit (RU), wherein the first RU is dedicated for low-latency traffic transmission and the first request frame includes a first duration for the coordination; and
transmitting, to the second AP, a first response frame accepting the request of the first request frame.

17. The method of claim 16, wherein the first request frame includes an identification for a STA designated to use the first RU for low-latency traffic transmission.

18. The method of claim 16, wherein:
the first request frame is a stream classification service (SCS) request frame including classification information and parameters provided by one or more STAs associated with the first AP; and
the first response frame is an SCS response frame.

19. The method of claim 16, wherein the method further comprising:
transmitting, to the second AP, a third request frame requesting coordination so that the second AP and one or more STAs in a BSS of the second AP avoid using a second RU, wherein the second RU is dedicated for low-latency traffic transmission; and
receiving, from the second AP, a fourth response frame accepting the request of the third request frame.

20. The method of claim 16, wherein the method further comprising:
transmitting, to the one or more STAs, a second request frame requesting that the one or more STAs avoid using the first RU for the first duration; and
receiving, from at least one of the one or more STAs, a second response frame accepting the request of the second request frame.
